(19) United States
(12) Patent Application Publication
(10) Pub. No.: US 2025/0138719 A1
(43) Pub. Date: May 1, 2025

(54) INFORMATION PROCESSING DEVICE AND NON-TRANSITORY, COMPUTER-READABLE RECORDING MEDIUM THEREFOR

(71) Applicant: Faurecia Clarion Electronics Co., Ltd., Saitama-shi (JP)

(72) Inventors: Takuma SHIOGUCHI, Saitama (JP); Keiichiro YOSHIHARA, Saitama (JP); Kenta YASUTOMO, Saitama (JP); Jun KAWANO, Saitama (JP); Takahiro UEMURA, Saitama (JP)

(21) Appl. No.: 18/925,399

(22) Filed: Oct. 24, 2024

(30) Foreign Application Priority Data
Oct. 27, 2023 (JP) 2023-184935

(51) Int. Cl. G06F 3/04847; G06F 3/04883

(52) U.S. Cl. CPC G06F 3/04847; G06F 3/04883

(57) ABSTRACT

An information processing device having a determination unit for determining whether a current state is a first state wherein a touch operation on a screen of a display device is easy for a user, or a second state wherein the touch operation is less easy for the user than when in the first state; and a display control unit that displays a first operator for adjusting a value related to content on the screen of the display device when in the first state, and displays a second operator for adjusting a value related to the content on the screen when in the second state. The first operator is capable of adjusting a value related to the content in a first value unit according to the touch operation, and the second operator is capable of adjusting a value related to the content in a second value unit larger than the first value.

### TECHNICAL FIELD

The present disclosure relates to an information processing device and to a computer program.

### BACKGROUND

An information processing device that displays, on a screen, an operator for adjusting a value relating to content is known. For example, a specific configuration of an information processing device of this type is taught in patent document 1 (JP 2010-36620 A).

The information processing device taught in patent document 1 is an on-board device and displays a slider bar for volume adjustment on a screen. The user may adjust the volume of music or the like by operating the slider bar.

### SUMMARY

In the case of a slider bar for which a precise operation is required, the time during which the user gazes at the screen (slider bar) tends to be longer compared to other operators or other forms. It is desirable to keep such gazing time short. On the other hand, there is also a demand for using an operator that enables value adjustment, such as a slider bar.

In light of the above circumstances, an object of an embodiment of the present disclosure is to provide an information processing device and a computer program capable of not only displaying an operator that enables precise value adjustment on a screen of a display device but also displaying an operator which easily keeps a gazing time short as necessary on the screen of the display device.

An information processing device according to an embodiment of the present disclosure is a device connected to a touch-operable display device provided with: a determination unit that determines whether a current state is a first state in which touch operation by a user on a screen of the display device is easy, or a second state in which the touch operation by the user is less easy than the first state; and a display control unit that displays a first operator for adjusting a value related to content on the screen of the display device when in the first state, and displays a second operator for adjusting the value related to the content on the screen of the display device when in the second state. The first operator is an operator capable of adjusting a value related to the content by a first value unit according to the touch operation. The second operator is an operator capable of adjusting a value related to the content by a second value unit larger than the first value in accordance with the touch operation.

According to an embodiment of the present disclosure, an information processing device and a computer program capable of not only displaying an operator that enables precise value adjustment on a screen of a display device but also displaying an operator which easily keeps a gazing time short as necessary on the screen of the display device are provided.

### BRIEF DESCRIPTION OF THE DRAWINGS

FIG. 1 is a block diagram illustrating a hardware configuration of an on-board device according to an embodiment of the present disclosure.

FIG. 2 is a diagram illustrating an example of a display screen displayed on a screen of a display unit in an embodiment of the present disclosure.

FIG. 3 is a diagram illustrating an example of a display screen when a touch operation is performed on the screen of the display unit in an easy-to-operate state.

FIG. 4 is a diagram illustrating an example of a display screen when a touch operation is performed on the screen of the display unit in the easy-to-operate state.

FIG. 5 is a diagram illustrating an example of a display screen when a touch operation is performed on the screen of the display unit in a non-easy-to-operate state.

FIG. 6 is a diagram illustrating an example of a display screen when a touch operation is performed on the screen of the display unit in the non-easy-to-operate state.

FIG. 7 is a flowchart illustrating processing executed by a control unit of the on-board device in an example of the present disclosure.

FIG. 8 is a subroutine of first main processing (step S103) of FIG. 7.

FIG. 9 is a subroutine of second main processing (step S104) of FIG. 7.

FIG. 10 is a diagram illustrating an example of a display screen displayed on a screen of a display unit in a separate embodiment of the present disclosure.

FIG. 11 is a diagram illustrating an example of a display screen displayed on a screen of a display unit in a further separate embodiment of the present disclosure.

FIG. 12 is a diagram illustrating an example of a display screen displayed on a screen of a display unit in a further separate embodiment of the present disclosure.

### DETAILED DESCRIPTION OF EMBODIMENTS

The following description relates to an information processing device and a computer program stored on a non-transitory, computer-readable recording medium according to an embodiment of the present disclosure. Note that common or corresponding elements are marked with the same or similar reference codes, and duplicate descriptions are simplified or omitted as appropriate.

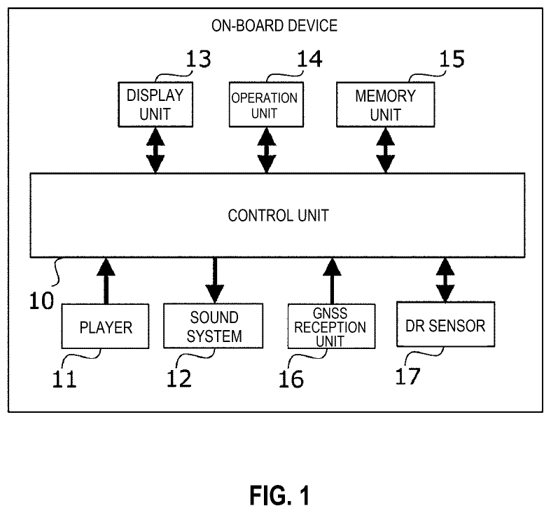

FIG. 1 is a block diagram illustrating a hardware configuration of an on-board device 1 according to an embodiment of the present disclosure. The on-board device 1 is, for example, mounted on a vehicle, which is an example of a moving body.

The on-board device 1 includes an information processing device connected to a touch-operable display device (a display unit 13 in the example of FIG. 1). The on-board device 1 is equipped with various functions including, for example, an audio function and a navigation function. Note that the on-board device 1 may be a device that forms a portion of in-vehicle infotainment (IVI).

As illustrated in FIG. 1, the on-board device 1 is provided with a control unit 10, a player 11, a sound system 12, a display unit 13, an operation unit 14, a memory unit 15, a global navigation satellite system (GNSS) reception unit 16, and a dead reckoning (DR) sensor 17.

The on-board device 1 may be provided with another configuration not illustrated in FIG. 1. In other words, there is a degree of freedom in the form of the on-board device 1, and various design changes are possible.

The player 11 is connected to a sound source. The player 11 plays an audio signal input from the sound source, which is then output to the control unit 10.

Examples of the sound source include disk media such as compact discs (CDs) and Super Audio CDs (SACDs), storage media such as hard disk drives (HDDs) and Universal Serial Buses (USBs), smartphones, tablet terminals that store digital audio data, and servers that perform streaming via a network. When the sound source is streamed or when the sound source is stored in the memory unit 15 described later, the player 11 as individual hardware may be omitted.

The control unit 10 is an example of the information processing device according to an embodiment of the present disclosure, and is an example of a computer that executes an information processing method and an information processing program according to the present embodiment.

The control unit 10 is configured, for example, as a large scale integration (LSI), and is provided with a central processing unit (CPU), a random access memory (RAM), a read only memory (ROM), and a digital signal processor (DSP).

In this way, the information processing device according to the present embodiment is incorporated in the on-board device 1 as the control unit 10. In another embodiment, the information processing device may be incorporated in a device of another form, such as a smartphone, feature phone, tablet terminal, personal computer (PC), personal digital assistant (PDA), portable navigation device (PND), or handheld game device.

The control unit 10 executes various programs developed in a work area of the RAM. Thus, the control unit 10 controls operation of the on-board device 1.

The control unit 10 is, for example, a single processor or a multiprocessor, and includes at least one processor. When configured to include a plurality of processors, the control unit 10 may be packaged as a single device or may be configured of a plurality of physically separate devices within the on-board device 1.

The control unit 10 processes a digital audio signal input from the player 11 or the memory unit 15, which is then output to the sound system 12.

The sound system 12 includes a D/A converter, amplifier, and the like. The digital audio signal is converted to an analog signal by the D/A converter. This analog signal is amplified by the amplifier and output to each speaker installed in a vehicle interior. As a result, music recorded in the sound source, for example, is played in the vehicle interior from each speaker.

The display unit 13 is a device that displays various screens and examples include displays configured of a liquid crystal display (LCD) or organic electro luminescence (EL). The display is equipped with a touch panel.

In other words, the display unit 13 is an example of a touch-operable display device. In addition, the control unit 10 is connected to the display unit 13 which is an example of a display device.

The operation unit 14 includes mechanical operators such as switches, buttons, knobs, and wheels, that are mechanical systems, capacitance non-contact systems, membrane systems, or the like. Furthermore, the display unit 13 equipped with a touch panel display forms a portion of the operation unit 14. A GUI on which touch-operable operators are disposed is displayed on the screen of the display unit 13.

The user may operate the on-board device 1 via a mechanical operator or an operator on the GUI (graphical user interface).

The memory unit 15 is an auxiliary storage device or a flash memory such as a hard disk drive (HDD) or solid state drive (SSD). Various programs such as an information processing program for executing the information processing method according to the present embodiment and various data such as map data for navigation are stored in the memory unit 15. In one example, the memory unit 15 includes a non-transitory, computer-readable recording medium having a computer program stored thereon that can be executed by an electronic processor of the information processing device. When the player 11 is omitted, sound source data is also stored in the memory unit 15.

The GNSS reception unit 16 measures the current position of the vehicle based on a GNSS signal received from a plurality of GNSS satellites. The GNSS reception unit 16 measures the current position at a predetermined time interval (for example, every second), and outputs the measurement result to the control unit 10. A representative example of GNSS is the Global Positioning System (GPS).

The control unit 10 renders the map data stored in the memory unit 15 to display a map on the screen of the display unit 13, acquires the current position measured by the GNSS reception unit 16, and superimposes a mark indicating a vehicle position on the acquired current position, a position on a road of the map displayed on the screen of the display unit 13 (map matching).

The DR sensor 17 includes various sensors such as a gyro sensor that measures an angular velocity related to a bearing in a horizontal plane of the vehicle and a vehicle speed sensor that detects a rotation speed of left and right driving wheels of the vehicle.

The control unit 10 may also estimate the current position from information acquired from the DR sensor 17. The control unit 10 may determine a final current position by comparing both the current position acquired from the GNSS reception unit 16 and the current position estimated based on the information acquired from the DR sensor 17.

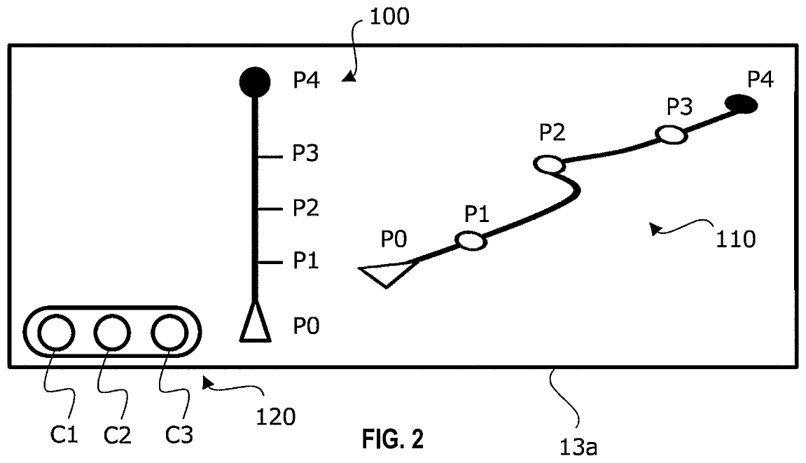

FIG. 2 illustrates an example of a display screen displayed on a screen 13a of the display unit 13. In the example of FIG. 2, a slider bar 100, a route 110, and a content list 120 are displayed on the screen 13a.

The control unit 10 accesses the map data, searches for a route from the current position to a destination set by a user operation using, for example, the Dijkstra method, and sets the searched route. When executing route guidance, the control unit 10 highlights the route in the map displayed on the screen of the display unit 13. The control unit 10 periodically acquires a current position, displays a map matched with the acquired current position on the screen of the display unit 13, and plays a voice signal for route guidance by a speaker at a proper time. When the current position deviates from the route, the control unit 10 again searches for and resets the route.

In FIG. 2, reference code 110 indicates a route set by the control unit 10. A point P0 indicates the current position of the vehicle. Points P1 to P3 indicate transit points on the route 110. A point P4 indicates the destination.

The control unit 10, for example, selects any three landmarks from among a plurality of landmarks located on the route 110, which are then displayed on the screen 13a. As a more specific example, the control unit 10 selects landmarks (in other words, sets points P1 to P3) so that distances between the points are as equal as possible, and displays these on the screen 13a.

The control unit 10 may divide the route 110 from the current position (point P0) to the destination (point P4) into four sections such that the distances of the sections are equal to each other, and set the divisions of the sections as the points P1 to P3, respectively.

The control unit 10 may divide the route 110 from the current position (point P0) to the destination (point P4) into four sections such that travel times of the sections are equal to each other, and set the divisions of the sections as the points P1 to P3, respectively. More specifically, at the time of searching for the route 110, the control unit 10 may estimate a time required to reach the destination from the current position, divide the estimated time into four equal parts, and set the points that the vehicle is expected to pass at the respective time divisions as the points P1 to P3, respectively.

The content list 120 is a list in which icons for executing various types of content are arranged and displayed. In the example of FIG. 2, content icons C1 to C3 are displayed in the content list 120. The user may display content icons other than the content icons C1 to C3 on the screen 13a by performing a scroll operation on the content list 120. In the present embodiment, the content is, for example, music.

The slider bar 100 is an example of the first operator for adjusting a value related to content. The value related to the content is, for example, a timing at which playback of the music is started. The value related to the content may be another value such as a volume of the content or a playback start point of the content.

Note that any reference to an element using a designation such as “first,” “second,” or the like as used in the present disclosure does not generally limit the quantity or order of those elements. These designations are used for convenience to distinguish between two or more elements. Thus, a reference to first and second elements does not mean, for example, that only two elements are employed or that the first element must precede the second element.

The user may, for example, adjust the timing of playback of the music by operating the slider bar 100. Hereinafter, this timing is referred to as “music playback start timing.” The music playback start timing may be rephrased as, for example, “point on the route 110” or “time (in other words, elapsed time from the current time).”

The user may adjust the music playback start timing within a predetermined range by touching the slider bar 100. The “predetermined range” is a point range from the current position (point P0) to the destination (point P4), or a time range from the current time to the expected destination arrival time. The reference codes P0 to P4 displayed on the slider bar 100 indicate points P0 to P4 on the route 110, respectively.

In other words, by operating the slider bar 100, the user may adjust the music playback start timing so that playback of the music is started when the vehicle passes through a certain point on the route 110, and may also adjust the music playback start timing so that playback of the music is started at a certain time.

The user may adjust the music playback start timing by a first value unit by operating the slider bar 100. The “first value” is, for example, a value corresponding to a minimum resolution detectable by the touch panel display, and is an extremely small value. Thus, the user may adjust the music playback start timing in a substantially stepless manner within a predetermined range.

In this manner, the slider bar 100 (an example of the first operator) may adjust the music playback start timing (an example of a value related to the content) by a first value unit within a predetermined range in response to a touch operation on the screen 13a.

Since the music playback start timing may be adjusted by fine units using the slider bar 100, when the slider bar 100 is operated, the time during which the user gazes at the screen 13a tends to be long. For example, when the user manually drives the vehicle at a speed exceeding an allowable range (for example, slow driving or low-speed driving in a traffic jam), it is desirable to keep such a gazing time short. Note that “manual driving” is driving in which the user performs various operations such as steering wheel operation, accelerator operation, or brake operation by himself without depending on a driving assistance device or an autonomous driving device.

Furthermore, for example, when the vehicle travels at a speed exceeding an allowable range, a finger touching the screen 13a is likely to shake due to vibration of the car body. Thus, it is difficult for the user to adjust the music playback start timing to an intended timing using the slider bar 100.

Thus, the operator to enable precise value adjustment, such as the slider bar 100, is unsuitable as operation means to be introduced into the environment of the vehicle cabin. On the other hand, there is also a demand for using an operator that enables value adjustment even during manual operation, such as a slider bar 100.

Also, the control unit 10 operates as a determination unit for determining whether a current state is a first state, wherein a touch operation on the screen 13a of the display unit 13 (one example of the screen of the display device) is easy for the user, or a second state wherein the touch operation is not as easy for the user as in the first state.

The second state is, for example, a state in which the user (driver) manually operates a vehicle (one example of a moving body) at a speed that exceeds the allowable range (for example, slow operation or slow operation in a traffic jam) (one example of the speed that exceeds the predetermined speed). In the second state, it is necessary for the user to concentrate on operation, and it is desirable to keep the user's time gazing at the screen 13a short. In addition, in the second state, the finger touching the screen 13a is likely to shake due to vibration of the vehicle body. It is desirable to ensure operability even in a situation where the finger is shaken by vibration. The second state may be rephrased as “a state in which it is difficult for the user to concentrate on the screen operation compared to the first state.”

In the second state, the control unit 10 displays a second operator for adjusting the music playback start timing on the screen 13a. As will be described in detail later, the second operator is an operator capable of adjusting the music playback start timing (one example of a value related to content) in units of a second value larger than the first value in response to a touch operation on the screen 13a.

In this way, in the second state, the control unit 10, in order to improve the operability, intentionally displays on the screen 13a the second operator that can only adjust the music playback start timing with coarse accuracy. Since the music playback start timing can only be adjusted with rough accuracy, the user's time gazing at the screen 13a becomes shorter, and even when the finger touching the screen 13a is shaken by the vibration of the vehicle body, it is easy to adjust the music playback start timing to the intended timing.

The first state is a state in which the vehicle is stopped (one example of a state in which the moving object is stopped) or a state in which the vehicle is moving in a state other than the second state. The “state other than the second state” is, for example, a state in which the user manually operates the vehicle at a low speed (equal to or lower than a predetermined speed) or a state in which the vehicle drives by automatic operation. The first state may be rephrased as “a state in which it is not difficult for the user to concentrate on screen operation.”

In the first state, the user is relatively able to look at the screen 13a. In addition, since the vibration of the vehicle body is small, the shaking of the finger touching the screen 13a is small. That is, in the first state, the user can relatively easily perform a touch operation on the screen 13a. Therefore, in the first state, the control unit 10 displays the slider bar 100 (one example of the first operator) for adjusting the music playback start timing (one example of a value related to the content), the slider bar 100 enabling precise value adjustment, on the screen 13a. Thereby, the user can precisely adjust the music playback start timing.

Thus, the control unit 10 operates as a display control unit that displays the slider bar 100 (one example of the first operator) on the screen 13a in the first state and displays the second operator (groups of buttons 130 and 140 described later) on the screen 13a in the second state. Note that in the above example, the state in which manual operation is performed at a speed within the allowable range is included in the first state, but it may be preferable to include this state in the second state in consideration of greater safety. For example, if the vehicle is equipped with an automatic braking system and safety at low speed is ensured, a manual operation state at a speed within an allowable range can be included in the first state, and if not, it is preferably included in the second state.

Hereinafter, the first state and the second state are referred to as an “easy-to-operate state” and a “non-easy-to-operate state,” respectively.

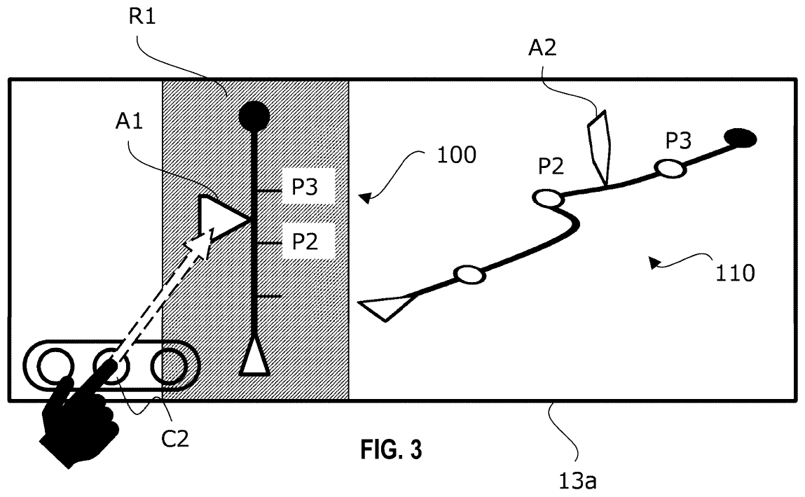

FIG. 3 illustrates an example of a display screen when a touch operation is performed on the screen 13a illustrated in FIG. 2 in the easy-to-operate state.

Note that the hand illustrated in drawings illustrating example screens, such as FIG. 3, indicates a state of a user touching the screen 13a. Furthermore, an outline arrow illustrated with a dashed line indicates motion of a finger of the user performing a drag operation on the screen 13a. Moreover, in drawings illustrating examples of display screens, for the convenience of clear illustration in the drawings, reference numerals P0 to P4 assigned to the slider bar 100 and the route 110 may be omitted. Also, for convenience of description, a portion of the screen 13a may be indicated by hatching.

By touching and dragging a content icon displayed in the content list 120 and dropping the dragged content icon near the slider bar 100, the user can set a music playback start timing of the music corresponding to the icon. The control unit 10 recognizes a rectangular region R1 indicated by hatching in FIG. 3 as the vicinity of the slider bar 100. Hereinafter, the region R1 is referred to as a “slider bar region R1.”

In the example of FIG. 3, the user touches a content icon C2, drags it to the vicinity of the slider bar 100, and drops it. Since the content icon C2 is dropped in the slider bar region R1, the control unit 10 displays arrow-shaped icons A1 and A2 at positions corresponding to the drop position, and sets a music playback start timing corresponding to the drop position.

For example, the control unit 10 displays the arrow-shaped icon A1 on the screen 13a of the display unit 13 so as to indicate a position on the slider bar 100 closest to the drop position. The control unit 10 further displays the arrow-shaped icon A2 at a position on the route 110 corresponding to the position indicated by the arrow-shaped icon A1. In the example of FIG. 3, arrow-shaped icons A1 and A2 are displayed at intermediate positions between a point P2 and a point P3.

The control unit 10 defines the position indicated by the arrow-shaped icon A1 (in other words, the position on the route 110 indicated by the arrow-shaped icon A2) based on data of the route 110 acquired by a route search (hereinafter referred to as “route data”). When the vehicle passes through the position indicated by the arrow-shaped icon A2, the control unit 10 starts playback of music corresponding to the content icon C2.

The scale on the slider bar 100 is in units of distance, but in other embodiments may be in units of time. In this case, reference numeral P0 indicates the current time. Reference numerals P1 to P3 indicate estimated passing times of the points P1 to P3 (in other words, elapsed time from the current time), respectively. Reference numeral P4 indicates an expected time of arrival at the destination P4.

The control unit 10 specifies a position on the route 110 corresponding to the time indicated by the arrow-shaped icon A1 (the elapsed time from the current time) based on the route data acquired by the route search. The control unit 10 displays the arrow-shaped icon A2 at the specified position on the route 110. In this case as well, when the vehicle passes through the position indicated by the arrow-shaped icon A2, the control unit 10 starts playback of music corresponding to the content icon C2. Furthermore, the control unit 10 may start playback of the music corresponding to the content icon C2 at the time indicated by the arrow-shaped icon A1.

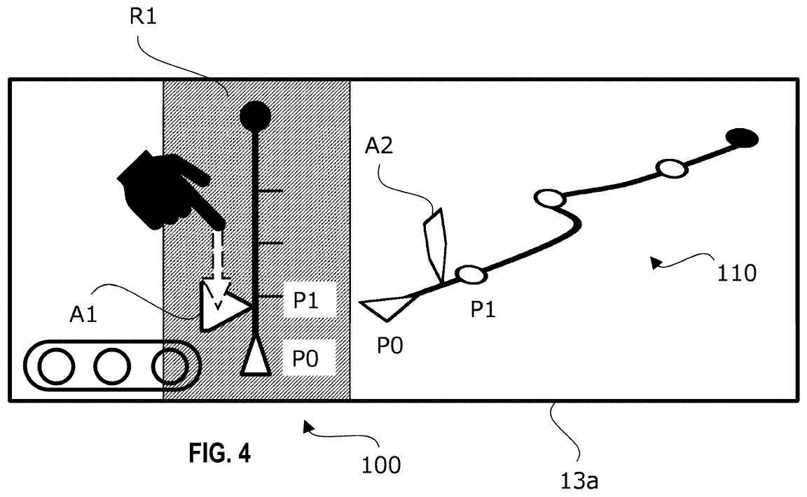

FIG. 4 illustrates a display screen example when a touch operation is performed on the screen 13a illustrated in FIG. 3 in the easy-to-operate state. In the example of FIG. 4, the user drags the arrow-shaped icon A1 from the position shown in FIG. 3 and drops it between the point P0 and the point P1. The control unit 10 moves the arrow-shaped icon A1 to the drop position and also moves the arrow-shaped icon A2 to a position on the route 110 corresponding to the position of the arrow-shaped icon A1 after the movement.

Note that when the user taps between the point P0 and the point P1, the arrow-shaped icon A1 moves from the position shown in FIG. 3 to the tap position, and the arrow-shaped icon A2 moves to a position on the route 110 corresponding to the position of the arrow-shaped icon A1 after the movement.

In this way, in the easy-to-operate state in which it is relatively easy to look at the screen 13a and vibration of the vehicle body is small, the user can easily perform precise touch operation. Therefore, the slider bar 100 for which it is possible to precisely adjust the music playback start timing is provided as operation means.

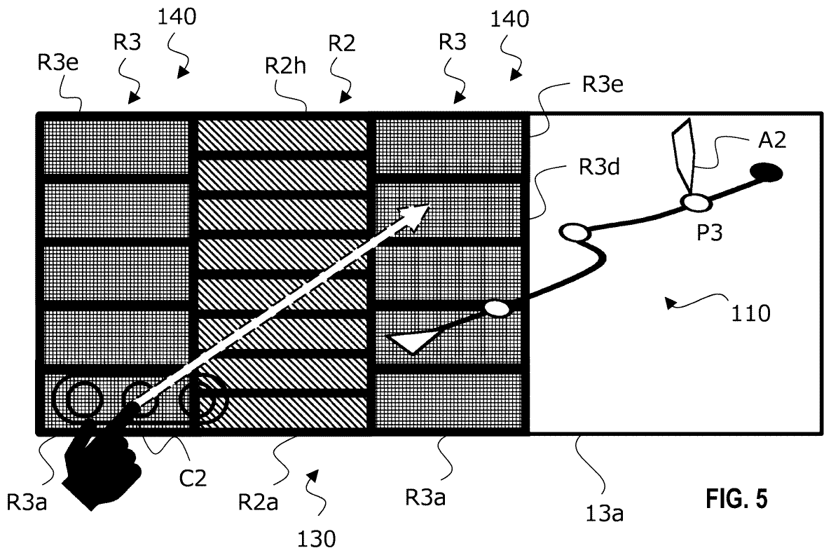

FIG. 5 illustrates an example of a display screen when a touch operation is performed on the screen 13a illustrated in FIG. 2 in the non-easy-to-operate state.

As illustrated in FIG. 5, in the non-easy-to-operate state, a group of buttons 130 in which eight buttons R2a to R2h are arranged in the vertical direction of the screen is displayed in a rectangular region R2 indicated by hatching, and a group of buttons 140 in which five buttons R3a to R3e are arranged in the vertical direction of the screen are displayed in respective rectangular regions R3 on both sides of the region R2. In the group of buttons 130, the buttons R2a to R2h are arranged in order from the lower part to the upper part of the region R2. In the group of buttons 140, the buttons R3a to R3e are arranged in order from the lower part to the upper part of the region R3.

Note that for convenience of clear illustration in the drawings, only some of the buttons R2a to R2h and R3a to R3e are given reference codes. Furthermore, in the following description, when the buttons R2a to R2h and R3a to R3e are collectively referred to, they are simply referred to as “buttons.” Hereinafter, the regions R2 and R3 are referred to as a “button operation region R2” and a “button operation region R3,” respectively.

The control unit 10 maps the buttons R2a and R2h to the current position (point P0) and destination (point P4), respectively. Also, the control unit 10 internally divides the route 110 from the current position (point P0) to the destination (point P4) into seven sections so that the distance of each section is equal and stores points acting as separators of each section. The control unit 10 associates each of the buttons R2b to R2g with a point serving as a separator of each section. In addition, the control unit 10 associates the buttons R3a to R3e with the points P0 to P4, respectively.

By touching and dragging a content icon displayed in the content list 120 and dropping the dragged content icon on any button, the user can set a music playback start timing of the music corresponding to the icon.

In the example of FIG. 5, the user touches a content icon C2 and drops it on the button R3d. As a result, the control unit 10 displays the arrow-shaped icon A2 at the point R3d associated with the button P3 which is the drop position, and sets the point P3 as the music playback start timing.

When the vehicle passes through the point P3 indicated by the arrow-shaped icon A2, the control unit 10 starts playback of music corresponding to the content icon C2.

The groups of buttons 130 and 140 are operators capable of adjusting the music playback start timing in eight stages and five stages, respectively. That is, the groups of buttons 130 and 140 are examples of a second operator that can adjust the music playback start timing (one example of a value related to content) in a value units (one example of the second value unit) larger than that of the slider bar 100, that can adjust the music playback start timing substantially in a stageless manner in response to a touch operation on the screen 13a.

In addition, the groups of buttons 130 and 140, which are examples of the second operator, are arranged by lining up a plurality of operators (here, buttons R2a to R2h and R3a to R3e) corresponding to a plurality of values related to content discretely distributed in a predetermined range (a point range from the current position (point P0) to the destination (point P4) or a time range from the current time to the expected destination arrival time among values relating to a plurality of contents (for example, points P0 to P4), the difference between at least two consecutive values (for example, the distance difference between point P0 and point P1) is a second value (for example, 10 km). A distance difference between the other two adjacent points (for example, a distance difference between the point P1 and the point P2) may be a third value (for example, 20 km) different from the second value.

The groups of buttons 130 and 140 may be formed by arranging a plurality of operators (here, buttons R2a to R2h and R3a to R3e) corresponding to values related to a plurality of contents discretely distributed at equal intervals within the predetermined range.

Each button is associated with a separation point when the route 110 is divided by distance, but may be associated with a separation time when the route 110 is divided by time (in other words, an elapsed time from the current time).

Each button in the button operation region R3 on both sides of the button operation region R2 may be associated with a separation point when the route 110 is divided by distance, or may be associated with a separation time when the route 110 is divided by time. Each button in one button operation region R3 may be associated with a separation point when the route 110 is divided by distance, and each button in the other button operation region R3 may be associated with a separation time when the route 110 is divided by time.

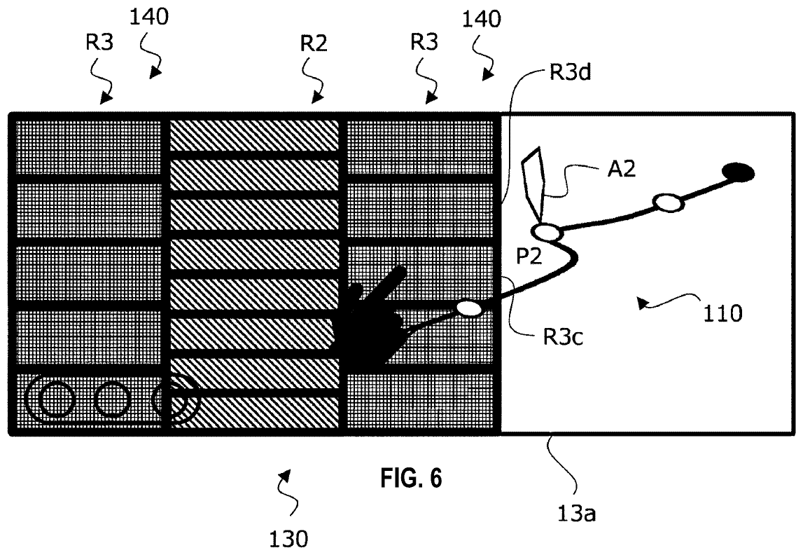

FIG. 6 illustrates a display screen example when a touch operation is performed on the screen 13a illustrated in FIG. 5 in the non-easy-to-operate state. In the example of FIG. 6, the user taps the button R3c. The control unit 10 moves the arrow-shaped icon A2 to a position on the route 110 indicating the point P2 associated with the tapped button R3c.

In this way, in the non-easy-to-operate state in which it is difficult to look at the screen 13a and vibration of the vehicle body is not small, it is difficult for the user to perform precise touch operation. Therefore, groups of buttons 130 and 140 for which it is possible to roughly adjust the music playback start timing are provided as operation means.

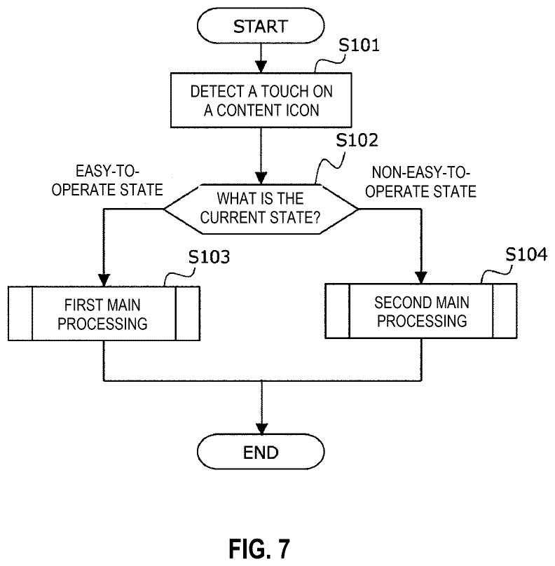

FIG. 7 is a flowchart illustrating the processing of a computer program, such as the information processing program, executed by an electronic processor of the control unit 10 in one embodiment of the present disclosure. For example, when the route search is performed and the route 110 is displayed on the screen 13a, execution of the processing shown in FIG. 7 is started. For example, the image illustrated in FIG. 2 is displayed on the screen 13a.

Note that the order of the steps in the flowcharts illustrated in the present embodiment may be changed as long as there is no inconsistency. Furthermore, the steps of the flowcharts shown in the present embodiment may be in parallel or in may be executed in parallel as long as there is no contradiction. For example, the present disclosure presents the processing of various steps using an example order, but such is not limited to the order presented.

The control unit 10 waits for a touch operation on a content icon arranged in the content list 120 (step S101). Upon detecting a touch operation on a content icon, the control unit 10 determines whether the current state is the easy-to-operate state or the non-easy-to-operate state (step S102).

When automatic operation is being performed, the control unit 10 determines that the current state is the easy-to-operate state. The control unit 10 determines that the current state is in an easy-to-operate state even when, during manual operation, the vehicle speed detected by the vehicle speed sensor included in the DR sensor 17 is less than or equal to a predetermined speed (during low-speed driving such as while stopped or during slow travel). Furthermore, during manual operation, when the vehicle speed detected by the vehicle speed sensor included in the DR sensor 17 exceeds a predetermined speed, it is determined that the current state is the non-easy-to-operate state.

When the current state is the easy-to-operate state (step S102: easy-to-operate state), the control unit 10 executes a first main process (step S103). When the current state is the non-easy-to-operate state (step S102: non-easy-to-operate state), the control unit 10 executes a second main process (step S104).

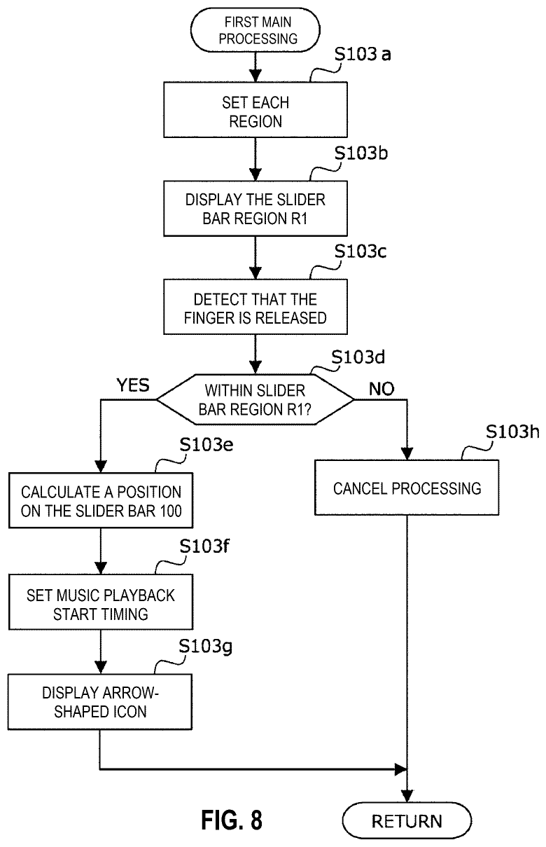

FIG. 8 is a subroutine of first main processing (step S103).

As illustrated in FIG. 8, the control unit 10 sets each region (step S103a). Specifically, the control unit 10 sets the slider bar region R1, and sets a region in the screen 13a other than the slider bar region R1 as a cancel region.

As illustrated in FIG. 3, the slider bar region R1 is a region including the slider bar 100 and extending from the lower end to the upper end of the screen 13a. The width of the slider bar region R1 can be set by user operation. FIG. 3 illustrates the slider bar region R1 when the width is set to a value of 100.

The size (width) of the slider bar region R1 may be dynamically changed according to the state of the vehicle. For example, during automatic driving and while stopped, it is easier to perform a touch operation than during manual driving at a low speed. Therefore, even when the width of the slider bar region R1 is narrow, the user can easily perform a touch operation. Therefore, the slider bar region R1 may be displayed in a narrow range (for example, a range of a value 70) during automatic driving or while stopped, and the slider bar region R1 may be displayed in a wide range (for example, a range of a value 100) during manual driving at low speed.

Narrowing the width of the slider bar region R1 during automatic driving or while stopped makes it possible to improve the visibility of other display elements (for example, the route 110).

The control unit 10 displays the slider bar region R1 on the screen 13a (step S103b). For example, the control unit 10 attaches a translucent, rectangular figure to the slider bar region R1 and displays the figure on the screen 13a.

When the control unit 10 detects that a user's finger has been released from the screen 13a (step S103c), the control unit 10 determines whether or not the position where the finger has been released (that is, the drop position of the content icon) is within the slider bar region R1 (step S103d).

When the drop position of the content icon is within the slider bar region R1 (step S103d: YES), the control unit 10 calculates a position on the slider bar 100 closest to the drop position in the coordinate system of the screen 13a (step S103e).

The control unit 10 calculates the position on the route 110 (in other words, the latitude and longitude) corresponding to the position on the slider bar 100 calculated in step S103e based on the route data, and sets the calculated position as the music playback start timing (step S103f).

The control unit 10 displays an arrow-shaped icon A1 on the screen 13a so as to indicate the position on the slider bar 100 calculated in step S103e, and displays an arrow-shaped icon A2 on a position on the route 110 corresponding to the position indicated by the arrow-shaped icon A1 (step. S103g). This allows, for example, the screen depicted in FIG. 3 to be displayed.

When the drop position of the content icon is outside the slider bar region R1, that is, in a cancel region (step S103d: NO), the control unit 10 cancels the drag operation of the content icon (step S103h). In this case, the music playback start timing is not set, and the arrow-shaped icons A1 and A2 are not displayed.

As described above, in the easy-to-operate state, the user can set the music playback start timing in smaller units by dropping the content icon at any position near the slider bar 100. Furthermore, as illustrated in FIG. 4, the user can adjust the music playback start timing in smaller units by dragging and dropping the arrow-shaped icon A1 in the slider bar region R1 or tapping any position in the slider bar region R1.

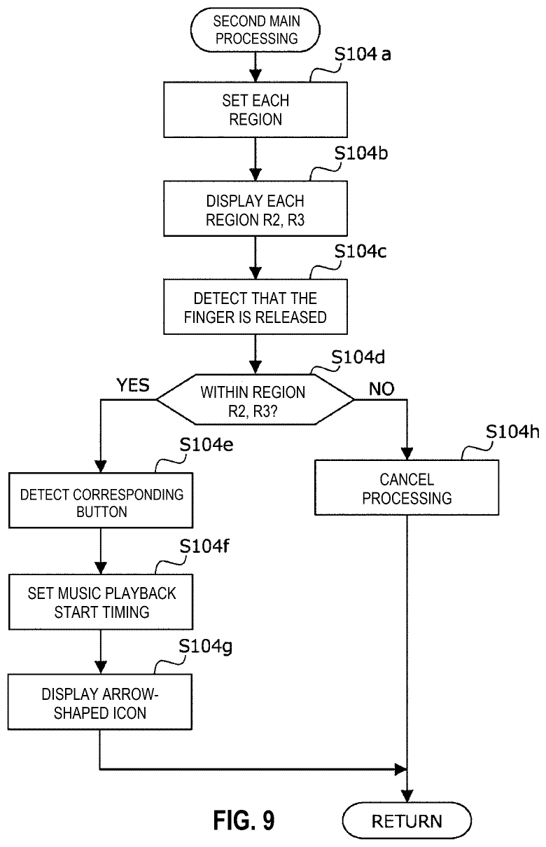

FIG. 9 is a subroutine of second main processing (step S104).

As illustrated in FIG. 9, the control unit 10 sets each region (step S104a). More specifically, the control unit 10 sets the button operation regions R2 and R3, and defines a region on the screen 13a other than the button operation region R2 and the button operation region R3 as the cancel region. In the button operation region R2, regions corresponding to the buttons R2a to R2h of the group of buttons 130 are set. In the button operation region R3, regions corresponding to the buttons R3a to R3e of the group of buttons 140 are set.

As illustrated in FIG. 5, the button operation regions R2 and R3 are regions extending from the lower end of the screen 13a to the upper end. The widths of the button operation regions R2 and R3 can be set by user operation. FIG. 5 illustrates the button operation regions R2 and R3 when both widths are set to a value of 100.

The sizes (widths) of the button operation regions R2 and R3 may be dynamically changed according to the state of the vehicle. For example, as the traveling speed increases during manual driving, accurate touch operation becomes more difficult. Therefore, the sizes (widths) of the button operation regions R2 and R3 may be increased as the traveling speed during manual driving increases in order to ensure operability.

The rate of change in the width according to the vehicle speed may be the same or different in the button operation region R2 and the button operation region R3. As an example, as the vehicle speed increases, the button operation region R3 may be wider than the button operation region R2. In other words, the ratio of the button operation region R3 with respect to the button operation region R2 may be increased.

The control unit 10 displays the button operation regions R2 and R3 on the screen 13a (step S104b). For example, the control unit 10 pastes and displays the translucent buttons R2a to R2h on the button operation region R2 and pastes and displays the translucent buttons R3a to R3e on the button operation region R3.

When the control unit 10 detects that a user's finger has been released from the screen 13a (step S104c), the control unit 10 determines whether or not the position where the finger has been released (that is, the drop position of the content icon) is within either region of the button operation regions R2 and R3 (step S104d).

When the drop position of the content icon is within one of the button operation regions R2 or R3 (step S104d: YES), the control unit 10 detects the button corresponding to the drop position (step S104e).

The control unit 10 calculates the position on the route 110 (in other words, the latitude and longitude) corresponding to the button detected in step S104e based on the route data, and sets the calculated position as the music playback start timing (step S104f).

The control unit 10 displays the arrow-shaped icon A2 at a position on the route 110 corresponding to the button detected in step S104e (step S104g). This allows, for example, the screen depicted in FIG. 5 to be displayed.

When the drop position of the content icon is in the cancel region (step S104d: NO), the control unit 10 cancels the drag operation of the content icon in a similar manner to step S103h (step S104h).

As described above, in the non-easy-to-operate state, the user can set the music playback start timing by dropping the content icon on any button. In addition, as illustrated in FIG. 6, the user can change the music playback start timing by tapping another button (performing an operation of releasing the finger touching the screen 13a from the screen 13a on said spot). That is, the user can roughly set or change the music playback start timing by an operation that does not require an accurate movement, such as an operation of dropping the content icon onto a button or an operation of tapping a button.

Note that an operation in which the user drops the content icon on any button has been described as an example to this point, but another operation may be used instead. For example, when the user taps a content icon, the icon is brought into a selected state, and when the user taps any button thereafter, the music playback start timing may be set.

Because the operation does not require accurate movements, the user's gazing time on the screen 13a can be made shorter. Moreover, the user can easily set the music playback start timing to an intended timing even in situations wherein the finger is shaken by vibration.

The description provided thus far is a description of exemplary embodiments of the present disclosure. The embodiments of the present disclosure are not limited to those described above, and various modifications are possible within the scope of the technical concept of the present disclosure. For example, appropriate combinations of embodiments and the like that are explicitly indicated by way of example in the specification or obvious embodiments and the like are also included in the embodiments of the present application.

In the embodiment described above, the slider bar region R1 is set when in the easy-to-operate state, and the button operation regions R2 and R3 are set when in the non-easy-to-operate state. However, the present disclosure is not limited to this.

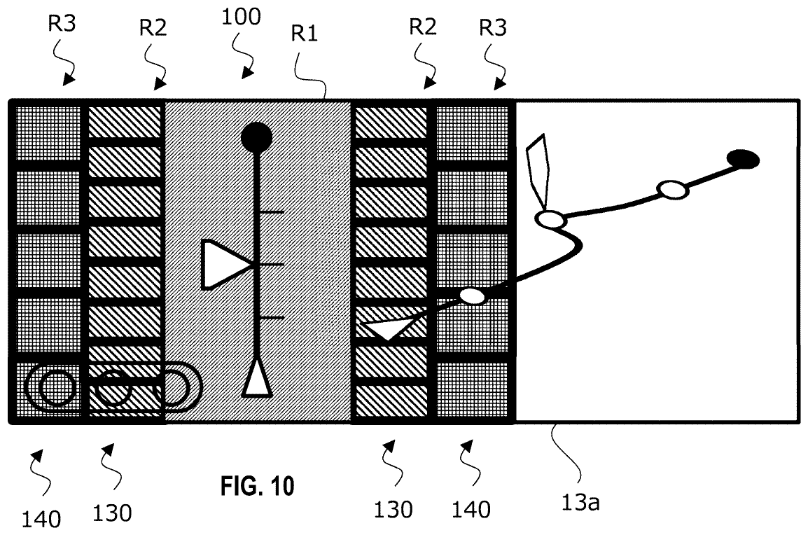

FIG. 10 illustrates a display screen in another embodiment of the present disclosure. For example, when in the easy-to-operate state, it is possible to set not only the slider bar region R1, but also the button operation regions R2 and R3. In this case, the user can finely adjust the music playback start timing by operating the slider bar 100, and can roughly adjust the music playback start timing by operating one of the groups of buttons 130 and 140.

That is, the control unit 10 operating as the display control unit may display the slider bar 100 (an example of a first operator) and the groups of buttons 130 and 140 (an example of a second operator) on the screen 13a when in the easy-to-operate state, and may display only the groups of buttons 130 and 140 among these operators on the screen 13a when in the non-easy-to-operate state.

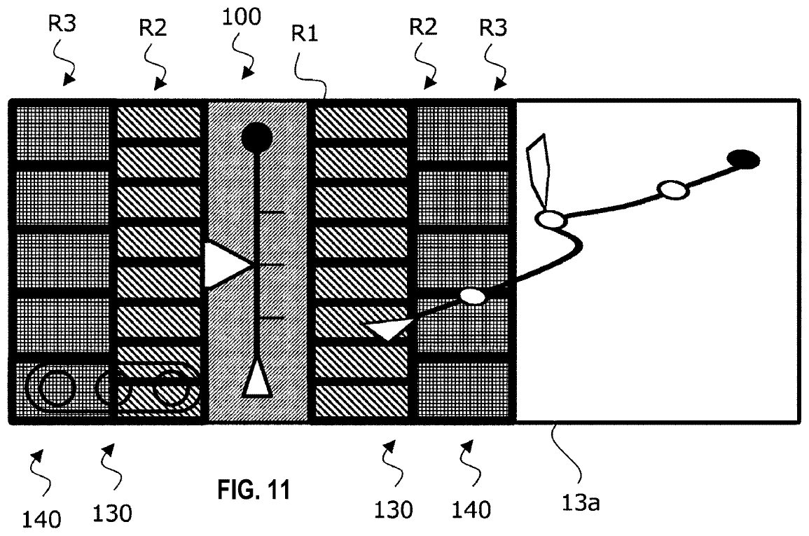

FIG. 11 illustrates a display screen in yet another embodiment of the present disclosure.

The control unit 10 may display the slider bar 100 and the groups of buttons 130 and 140 on the screen 13a in both the easy-to-operate state and the non-easy-to-operate state. In this case, when in the non-easy-to-operate state, the control unit 10 may display the groups of buttons 130 and 140 on the screen 13a in a larger size than when in the easy-to-operate state.

For example, in the easy-to-operate state, as illustrated in FIG. 10, the control unit 10 displays the slider bar region R1 and the groups of buttons 130 and 140 on the screen 13a. In the non-easy-to-operate state, as illustrated in FIG. 11, the control unit 10 displays the slider bar region R1 and the groups of buttons 130 and 140 on the screen 13a. That is, when in the non-easy-to-operate state, the control unit 10 displays the slider bar region R1 in a smaller size and displays the groups of buttons 130 and 140 in a larger size on the screen 13a than when in the easy-to-operate state.

In this manner, the slider bar region R1 is displayed in a larger size in the easy-to-operate state and the groups of buttons 130 and 140 are displayed in a larger size in the non-easy-to-operate state, thereby securing good operability in any state.

Although the group of buttons 130 and the group of buttons 140 are displayed as a set in the embodiment described above, only one of the group of buttons 130 and the group of buttons 140 may be displayed in another embodiment.

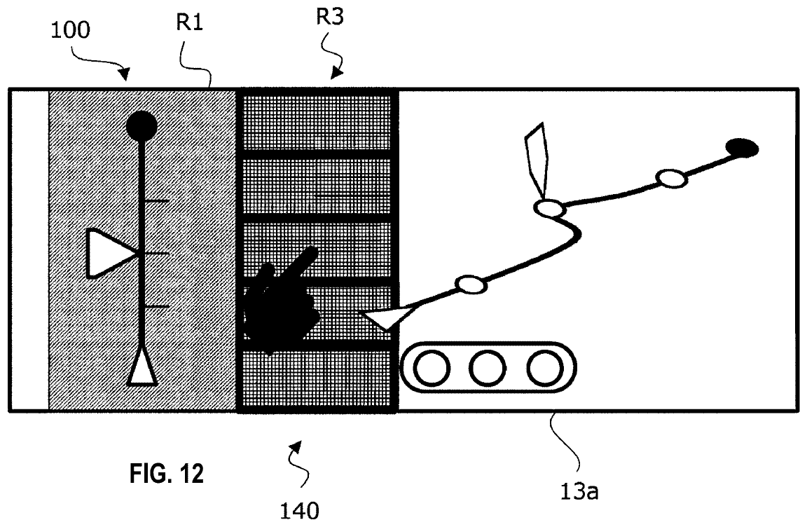

FIG. 12 illustrates a display screen in yet another embodiment of the present disclosure.

The position on the screen 13a where operation is easy differs depending on the user. Therefore, the positions of the slider bar region R1 and the button operation regions R2 and R3 can be arbitrarily changed by user operation.

As illustrated in FIG. 12, a case will be described wherein the position of the slider bar region R1 is changed to the vicinity of the left end of the screen 13a. In this case, because the space next to the slider bar region R1 on the left is narrow, it is impossible to display the group of buttons 130 and the group of buttons 140 next to the slider bar region R1 on the left. In this case, the control unit 10 displays the group of buttons 140 only next to the slider bar region R1 on the right.

Note that in the example in FIG. 12, the control unit 10 may display the group of buttons 130 next to the slider bar region R1 on the right instead of or in addition to the group of buttons 140.

### DESCRIPTION OF REFERENCE NUMERALS

1: On-board device
10: Control unit
13: Display unit
100: Slider bar
130: Group of buttons
140: Group of buttons

1. An information processing device connected to a touch-operable display device, comprising:
a determination unit for determining whether a current state is a first state wherein a touch operation on a screen of the display device is easy for a user, or a second state wherein the touch operation is less easy for the user than when in the first state; and
a display control unit that displays a first operator for adjusting a value related to content on the screen when in the first state, and displays a second operator for adjusting a value related to the content on the screen when in the second state; wherein
the first operator is an operator capable of adjusting a value related to the content in a first value unit according to the touch operation; and
the second operator is an operator capable of adjusting a value related to the content in a second value unit larger than the first value in accordance with the touch operation.

2. The information processing device according to claim 1, wherein:
the information processing device is installed in a moving body;
the first state includes at least a state wherein the moving body is stopped; and
the second state includes at least a state wherein the movable body moves at a speed exceeding a predetermined speed via manual driving by a driver.

3. The information processing device according to claim 1, wherein the display control unit:
displays the first operator and the second operator on the screen when in the first state; and
displays only the second operator from among the first operator and the second operator on the screen when in the second state.

4. The information processing device according to claim 1, wherein the display control unit:
displays the first operator and the second operator on the screen in either of the first state or the second state; and
displays the second operator on the screen in a larger size compared to the first state when in the second state.

5. The information processing device according to claim 1, wherein the first operator:
is a slider bar capable of adjusting a value related to the content in the first value unit within a predetermined range according to the touch operation, and
the second operator:
has a plurality of operators corresponding to a plurality of values related to the content discretely distributed within the predetermined range disposed side by side, wherein a difference between at least two consecutive values among the plurality of values relating to the content is the second value.

6. A non-transitory, computer-readable recording medium having stored thereon a computer program that, when executed by an electronic processor of an information processing device that is connected to a touch-operable display device, configures the information processing device to: determining whether a current state is a first state wherein a touch operation on a screen of the display device is easy for a user, or a second state wherein the touch operation is less easy for the user than when in the first state; and
processing for displaying a first operator for adjusting a value related to content on the screen when in the first state, and displaying a second operator for adjusting a value related to the content on the screen when in the second state; wherein
the first operator is an operator capable of adjusting a value related to the content in a first value unit according to the touch operation; and
the second operator is an operator capable of adjusting a value related to the content in a second value unit larger than the first value in accordance with the touch operation.
